(19) United States
(12) Patent Application Publication
(10) Pub. No.: US 2010/0328029 A1
(43) Pub. Date: Dec. 30, 2010

(54) METHOD AND APPARATUS FOR COMMUNICATION DEVICE

(76) Inventor: Martin Edward Kolek, Kent (GB)

Correspondence Address: BUCKLEY, MASCHOFF & TALWALKAR LLC, 50 LOCUST AVENUE, NEW CANAAN, CT, 06840, US

(21) Appl. No.: 12/494,613

(22) Filed: Jun. 30, 2009

(51) Int. Cl. G05B 19/00

(52) U.S. Cl. 340/5.9

(57) ABSTRACT

In some embodiments, apparatus includes: a communication device to receive a plurality of removable information devices and transmit information to a proximity coupling system, the communication device including: a body; a plurality of electrical interfaces supported by the body, each of the plurality of electrical interfaces to electrically connect to a contact interface of an associated one of the plurality of removable information devices; a controller supported by the body to (i) determine which one of the plurality of removable information devices is selected by a user and (ii) receive information from the selected one of the plurality of removable information devices through a one of the plurality of electrical interfaces that is associated with the selected one of the plurality of removable information devices; and a wireless communication interface supported by the body to transmit information to the proximity coupling system, wherein the transmitted information is based at least in part information on the information received from the selected one of the plurality of removable information devices.

### BACKGROUND

Proximity payment cards are in widespread use. A well known standard for such cards has been promulgated by MasterCard International Incorporated, the assignee hereof, and is referred to as “PayPass”. Proximity payment cards typically include a radio frequency identification (RFID) integrated circuit (IC) embedded in a card-shaped plastic body. An antenna is also embedded in the card body. The antenna allows the card to receive a power signal from a point of sale terminal. The antenna is also used by the RFID IC to transmit the payment card account number, and possibly other information as well, to the POS terminal.

### BRIEF DESCRIPTION OF THE DRAWINGS

FIG. 1 is a schematic block diagram of a system, according to some embodiments;

FIG. 2A is a perspective view of a communication device and an information device of FIG. 1, according to some embodiments, with the communication device in an open state and the information device not installed in the communication device.

FIG. 2B is a perspective view of the communication device and the information devices of FIG. 1, according to some embodiments, with the communication device in an open state and the information devices installed in the communication device.

FIG. 3 is a schematic plan view of a portion of the communication device of FIGS. 2A-2B, according to some embodiments.

FIG. 4 is a schematic block diagram of a control and proximity coupling system portion of the communication device of FIGS. 2A-2B and FIG. 3, according to some embodiments.

FIG. 5 is a schematic block diagram of a proximity coupling system, according to some embodiments.

FIG. 6 is a schematic block diagram of a proximity coupling device, according to some embodiments.

FIG. 7 is a schematic block diagram of an information device, according to some embodiments.

FIG. 8 is a plan view of a structure, according to some embodiments.

FIG. 9 is cross sectional view of a structure along the direction A-A of FIG. 8, according to some embodiments.

FIG. 10 is a perspective view of the structure of FIG. 8, with a portion of the structure being detached, according to some embodiments.

FIG. 11 is a perspective view of a communication device and an information device, according to some embodiments, with the communication device in an open state.

FIG. 12 is a perspective view of a communication device and an information device, according to some embodiments, with the communication device in an open state.

FIG. 13A is a perspective view of a communication device and an information device, according to some embodiments.

FIG. 13B is a schematic plan view of a portion of the communication device of FIG. 13A, according to some embodiments.

FIG. 14A is a perspective view of a communication device and an information device, according to some embodiments.

FIG. 14B is a schematic plan view of a portion of the communication device of FIG. 14A, according to some embodiments.

FIG. 15 is a perspective view of a communication device and an information device, according to some embodiments.

FIG. 16 is a schematic plan view of a portion of the communication device of FIG. 15, according to some embodiments.

FIG. 17 is a perspective view of a communication device and an information device, according to some embodiments.

FIG. 18 is a schematic plan view of a portion of the communication device of FIG. 17, according to some embodiments.

FIG. 19 is a schematic plan view of a portion of a communication device and an information device, according to some embodiments.

FIG. 20 is a block diagram of an architecture, according to some embodiments.

FIG. 21 is a perspective view of a communication device, according to some embodiments.

FIG. 22 is a perspective view of a communication device, according to some embodiments.

FIG. 23 is a perspective view of a communication device and a mobile device, according to some embodiments.

FIG. 24 is a perspective view of a communication device and a mobile device, according to some embodiments.

FIG. 25 is a flow chart that illustrates a method, according to some embodiments.

FIG. 26 is a flow chart that illustrates a method, according to some embodiments.

FIG. 27 is a flow chart that illustrates a method, according to some embodiments.

### DETAILED DESCRIPTION

It has been determined that it would be desirable to provide a device that (i) has the ability to receive and hold a plurality of removable payment cards that include payment account information but by themselves lack the ability to engage in wireless communication, (ii) allows one of such payment cards to be selected (iii) receives payment account information from the selected payment card and (iv) transmits the payment account information to a proximity coupling system associated with a point of sale terminal to facilitate a wireless payment transaction.

It has also been determined that it would also be desirable to provide a device that is not limited to receiving, holding and/or selection of payment cards, but rather (i) has the ability to receive and hold removable information devices of any of various types that by themselves lack the ability to engage in wireless communication (ii) allows one of such information devices to be selected (iii) receives information from the selected information device and (iv) transmits the information to a proximity coupling device to facilitate a wireless transaction of any of various types.

It has also been determined that it would also be desirable to provide for mounting and/or otherwise attaching the device to another mobile device.

In some embodiments, the wireless communication is preferably short range wireless communication, more preferably near field communication.

Some embodiments disclosed hereinafter may address one or more of the above.

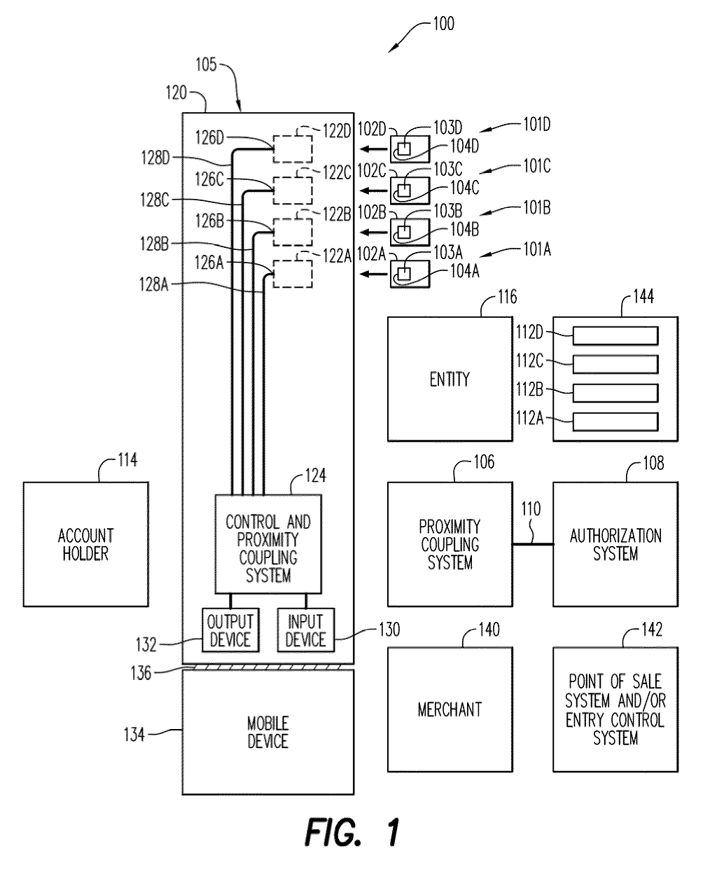

FIG. 1 is a schematic block diagram of a system 100, in accordance with some embodiments. The system 100 includes a plurality of information devices 101A-101D, a communication device 105, a proximity coupling system 106, an authorization system 108 and a communication link 110.

Each of the information devices 101A-101D may include a body, a control and/or storage device and a contact interface to electrically connect to the control and/or storage device. For example, information device 101A includes a body 102A, a control and/or storage device 103A and a contact interface 104A. Information device 101B includes a body 102B, a control and/or storage device 103B and a contact interface 104B. And so on.

In some embodiments, each of the bodies 102A-102D is generally card shaped and/or has dimensions as defined for the standard card “ID0000” in ISO/IEC standard 7810, promulgated by the International Standardization Organization. Each control and/or storage device 104A-104D may comprise an integrated circuit and/or any other type of control and/or storage device.

One or more of the information devices 101A-101D may be associated with a payment account and may be issued to an account holder by a bank, a transit system and/or other entity. For example, in some embodiments, information devices 101A-101D may be associated with payment accounts 112A-112D, respectively, and may be issued to an account holder 114 by a bank, a transit system and/or other entity, identified in FIG. 1 as entity 116.

The communication device 105 may include a body 120 and a plurality of seats 122A-122D to receive and hold the information devices 101A-101D, respectively. The information devices 101A-101D, by themselves, lack the ability to engage in wireless communication. However, the communication device 105 further includes a control and proximity coupling system 124 as well as a plurality of electrical interfaces 126A-126D and associated conductors 128A-128D that couple the information devices 101A-101D, to the control and proximity coupling system 124.

The control and proximity coupling system 124 is further coupled to an input device 130 to allow selection of one of the information devices 101A-101D. The control and proximity coupling system 124 may be further coupled to an output device 132 so as to provide an indication as to which of the information devices 101A-101D is selected.

As further described below, if the account holder 114 and/or user desires a wireless transaction, the account holder 114 and/or user may determine which of the information devices 101A-101D is to be used in the wireless transaction. The account holder 114 and/or user may thereafter use the output device 132 to determine whether the desired information device is already selected, and if it is not already selected, the account holder may use the input device 130 to select it. The account holder 114 may thereafter present the communication device 105 to the proximity coupling system 106.

The control and proximity coupling system 124 may receive information from the selected information device and may transmit the information to the proximity coupling system 106 to facilitate a wireless transaction.

If the wireless transaction is a purchase transaction, the information received from the selected information device may include payment account information that may be used to identify the payment account associated with the selected information device. The proximity coupling system 106 may receive the payment account information and may initiate a payment transaction in response at least thereto. Initiating the purchase transaction may include communicating with the authorization device 108 via the communication link 110 to obtain authorization to proceed with the purchase transaction.

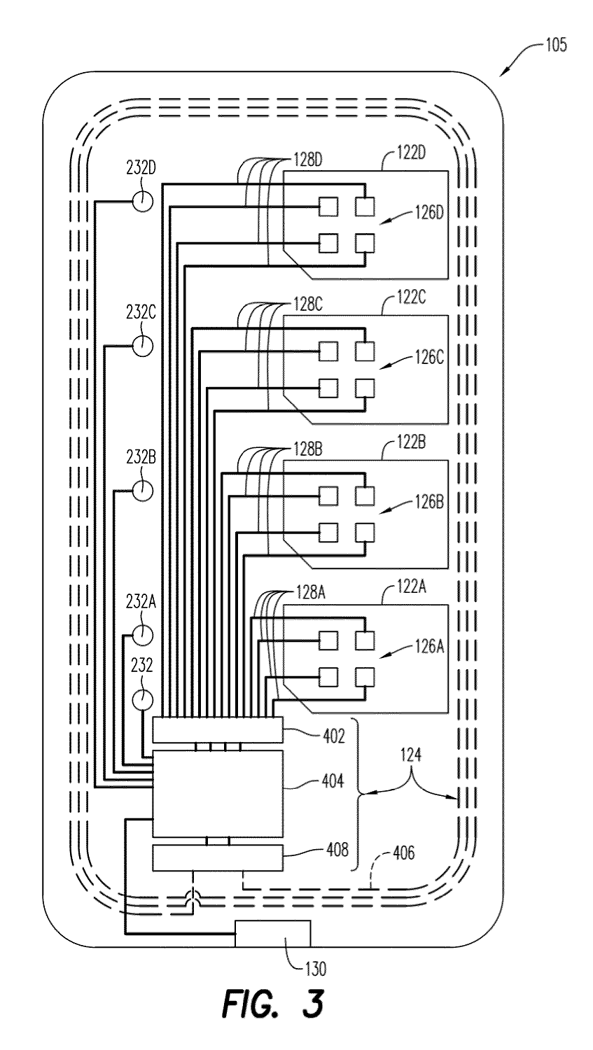

In some embodiments, the above may be carried out in accordance with the above-mentioned “PayPass” standard. For example, the communication device 105 may be presented to the proximity coupling system 106 and the proximity coupling system 106 may transmit an interrogation signal in response at least thereto. The communication device 105 may receive the interrogation signal via an antenna 406 (FIGS. 3-4). The interrogation signal may cause the circuitry of the communication device 105 to be powered-up. For example, the communication device 105 may include circuitry to rectify the received interrogation signal to generate DC power that may be used to power the control and proximity coupling system 124 and further used to power the selected information device. The communication device 105 may receive information from the selected information device and may transmit information based at least in part thereon to the proximity coupling system 106. The one or more signals may be transmitted via the antenna 406 (FIGS. 3-4) and may include a payment card account number and/or other information required for interaction with the proximity coupling system 106. In some embodiments, the proximity payment system may transmit the payment card account number and/or other information after a handshake procedure or the like with the proximity coupling system 106. This may include communicating with a payment card system to initiate a payment transaction against the payment card account represented by the payment card account number received from the selected information device. In some embodiments, the payment card system includes the authorization device 108 (FIG. 1).

In some embodiments, communication device 105 is presented to the proximity coupling system 106 by positioning the communication device 105 within wireless communication range of the proximity coupling system 126. In some embodiments, the proximity payment device may be presented to the proximity payment device by positioning the communication device 105 in physical contact with, and/or by tapping a portion of the communication device on, the proximity coupling system.

The proximity coupling system 106 may be disposed at a location operated by a merchant 140 and/or other entity and may be associated with (and/or coupled to) a point of sale and/or entry control system 142.

The authorization system 108 may comprise a website and/or other device associated with (e.g., operated by and/or on behalf of) an issuer of payment cards. The authorization system may be coupled to a processing system 144 that maintains payment accounts 112A-112D and/or to a point of sale and/or entry control system 142 associated with and/or coupled to the proximity coupling system 106.

The communication link 110 may couple the proximity coupling system 106 and the authorization device 108.

In some embodiments, the communication device 105 further includes a power source, e.g., a battery (not shown). This may improve one or more operating characteristics of the communication device 105, such as for example, giving the communication device 105 a greater range, allowing the communication device 105 to perform a greater number of functions and/or increasing the operating speed of the communication device 105.

In some embodiments, communication device 105 is mounted and/or otherwise attached to a mobile device 134. In some embodiments, adhesive is disposed between the communication device 105 and the mobile device 134 to accomplish this. In some embodiments, the mobile device 800 may comprise a cell phone, a music player, a video player, a personal digital assistant (PDA) and/or a wristwatch.

Various embodiments of the system 100 are further described below.

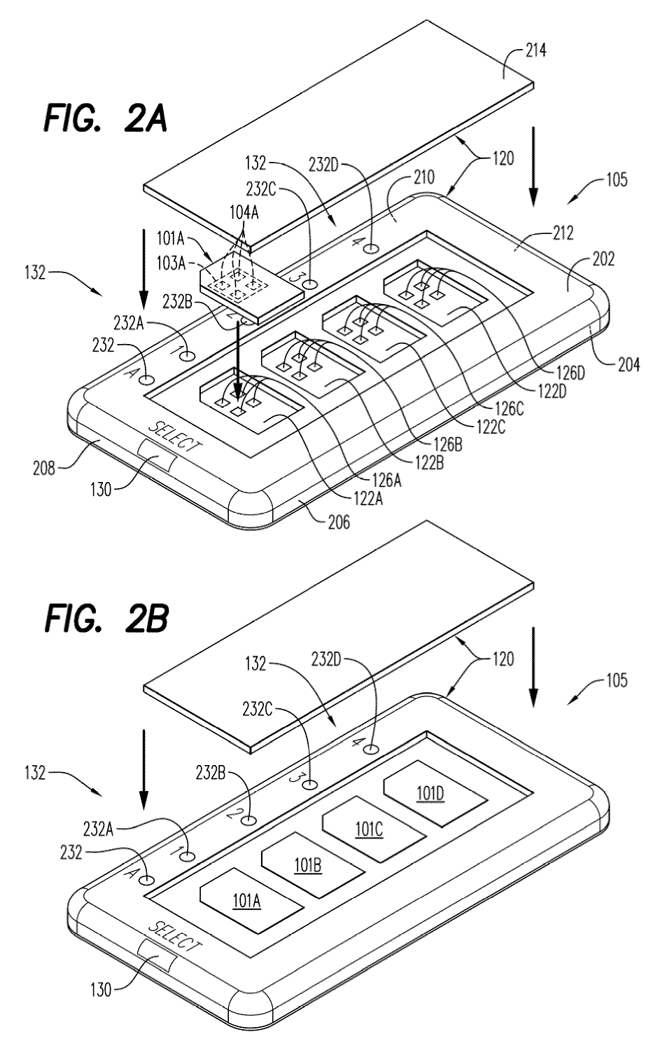

FIG. 2A is a perspective view of the communication device 105 and the first information devices 101A, according to some embodiments.

FIG. 2B is a perspective view of the communication device 105 and the information devices 101A-101D of FIG. 1, according to some embodiments, with the communication device 105 in an open state and the information devices 101A-101D installed in the communication device 105.

Referring to FIGS. 2A-2B, in some embodiments, the body 102A-102D of each information device 101A-101D may be generally card shaped and may include a key, e.g., a beveled corner. Each contact interface 104A-104D may comprise a plurality of contacts, e.g., four, which may be arranged, e.g., in an array, e.g., a 2×2 array as shown. In some embodiments, two of the contacts may be for signals. The other two contacts may be to receive power.

The body 120 of the communication device 105 may have a generally rectangular shape and may include a front 202, a back 204 and sides 206-212. The generally rectangular shape may include rounded corners and edges such that the entire outer surface of the body 120 is generally smooth. One or more portions of the body 120 may be movable relative to one or more other portions of the body 120 so as to provide access to seats 122A-122D and thereby facilitate installation and/or removal of the information devices 101A-101D. In the illustrated embodiment, a portion 214 of the front 202 is detachable from the rest of the body 120. In some embodiments, a releasable catch (not shown) is provided to releasably retain the portion 214 to the rest of the body 120 when the user does not desire access to the access to seats 122A-122D.

Although the body 120 is shown having a generally homogeneous composition, this is not required in all embodiments.

FIG. 3 is a schematic plan view of a portion of the communication device of FIGS. 2A-2D, according to some embodiments.

Referring also now to FIG. 3, each of the electrical interfaces 126A-126D may include a plurality of contacts adapted make contact with the contacts of the associated information device. For example, the electrical interface 126A of the communication device 105 may include a plurality of contacts adapted make contact with the contacts of the contact interface 104A of the first information device 101A. The electrical interface 126B of the communication device 105 may include a plurality of contacts adapted make contact with the contacts of the contact interface 104B of the second information device 101B. And so on.

Each seat 122A-122D may be adapted to receive the associated information device 101A-101D, respectively, and support and/or position the associated information device 101A-101D, respectively, relative to the communication device 105 such that the contact interface 104A-104D, respectively, of the associated information device 101A-101D, respectively, is in register with the associated electrical interface 126A-126D, respectively, of the communication device 105, at least in part.

For example, the seat 122A may be adapted to receive the information device 101A and to support and/or position the information device 101A relative to the communication device 105 such that the contact interface 104A of the information device 101A is in register with the electrical interface 126A of the communication device 105, at least in part. The contacts of the electrical interface 126A may be biased (e.g., in the z direction) so as to help insure contact with respective contacts of the information device 101A. In some embodiments, each contact of the electrical interface 126A is a spring contact that includes a contact and a spring integral therewith to bias the spring contact (e.g., in the z direction). In some embodiments, one or more springs may be provided on a portion of the body to bias the information device 101A toward the electrical interface 12A.

Although the seats 122A-122D are shown defined by and/or integral with the body 120, this is not required in all embodiments.

The conductors 128A-128D may electrically the electrical interfaces 126A-12D to the controller and proximity coupling system 124, thereby electrically connecting the controller and proximity coupling system 124 to the information device 101A.

The conductors 128A may electrically the electrical interface 126A to the controller and proximity coupling system 124 thereby electrically connecting the controller and proximity coupling system 124 to the information device 101A.

Each of the conductors 128A-128D may include a plurality of conductors adapted electrically connect the contacts of the associated electrical interface to the controller and proximity coupling system 124 so that the controller and proximity coupling system 124 is electrically connected to each information device 101A-101D. For example, the conductors 128A may include a plurality of conductors that electrically connect the contacts of the electrical interface 126A to the controller and proximity coupling system 124 so that the controller and proximity coupling system 124 is electrically connected to the first information device 101A. The conductors 128B may include a plurality of conductors that electrically connect the contacts of the electrical interface 126B to the controller and proximity coupling system 124 so that the controller and proximity coupling system 124 is electrically connected to the second information device 101B. And so on.

The input device 130 may comprise a switch that allows a user to change which of the information devices 101A-101D is selected. In one embodiment, the switch has two positions (e.g., corresponding to pressed or not pressed). Pressing or otherwise causing the switch to transition from the first position to the second position may indicate that the user desires a new selection. The control and proximity coupling system 124 may receive a signal indicating the transition and in response may change the selection to the next information device in a predetermined sequence. For example, if the first information device 101A is currently selected, pressing or otherwise causing the switch to transition from the first position to the second position may cause the second information device 101B to be selected. Pressing or otherwise causing the switch to again transition from the first position to the second position may cause the third information device 101C to be selected. Pressing or otherwise causing the switch to again transition from the first position to the second position may cause the fourth information device 101D to be selected. Pressing or otherwise causing the switch to again transition from the first position to the second position may cause the first information device 101A to be selected again. The user may stop pressing or otherwise actuating the switch when the desired information device is selected. In some embodiments, the switch may comprise a push on/push off type switch and/or a momentary type switch.

The output device 132 may comprise a plurality of indicators 232, 232A-232D. Each of the indicators 232A-232D may be associated with a respective one of the information devices 101A-101D and may provide a visible indication that indicates whether the associated one of the information devices 101A-101D, respectively, is selected. For example, the first indicator 232A may indicate whether the first information device 101A is selected. The second indicator 232B may indicate whether the second information device is selected. And so on. Each indicator 232A-232D may be controlled by a signal from the control and proximity coupling system 124 that indicates whether the associated information device 101A-101D, respectively, is selected. The indicator 232 may provide a visible indication to indicate whether the selected information device was selected automatically, i.e., by the communication device, or in response to user input via the input device. The indicator 232 may be controlled by a signal from the control and proximity coupling system 124 that indicates whether the selected information device was selected automatically. In some embodiments, each of the indicators 232, 232A-232D comprises a light emitting diode (LEDs) and/or other suitable device.

In some embodiments, the seats 122A-122D, the control and proximity coupling system 124, the plurality of electrical interfaces 126A-126D, the conductors 128A-128D, the input device 130 and the output device 132 are all supported, directly and/or indirectly, by the body 120. The body 120 may also receive and/or support the information devices 101A-101D, directly and/or indirectly.

FIG. 4 is a schematic block diagram of the control and proximity coupling system, according to some embodiments.

Referring to FIG. 4, in accordance with some embodiments, the control and proximity coupling system 124 may include a switch network 402, control/storage circuitry 404 and a wireless communication interface 405.

The switch network 402 may be coupled to the information devices 101A-101D (FIG. 1) and to the control/storage circuitry 404, which may be coupled to the input device 130, the output device 132 and the wireless communication interface 405 The wireless communication interface 405 may comprise an antenna 406 and transmit/receive circuitry 408. The antenna 406 may be configured to transmit and receive radio frequency (RF) signals, e.g., signals 410, 412, respectively, and may comprise a loop antenna and/or any other suitable configuration. The antenna 406 may be contained in and/or supported on the body 120.

In some embodiments, selection of an information device causes the control/storage circuitry 404 to supply one or more signals to close switches (e.g., four switches) in the switching network 402 to connect the selected information device to the control/storage circuitry 404. For example, selection of the first information device 101A may cause the control/storage circuitry 404 to supply one or more signals to close switches (e.g., four switches) in the switching network 402 to connect the first information device 101A to the control/storage circuitry 404. Selection of the second information device 101B may cause the controller and proximity coupling system 124 to supply one or more signals to close switches (e.g., four switches) in the switching network to connect the second information device 101B to the control/storage circuitry 404. And so on.

The control/storage circuitry may thereafter supply power to, and communicate with, the selected information device.

The control/storage circuitry 404 may store a payment account identifier (which may be a payment account number) and/or other information that is received from a selected information device and to be transmitted to an external proximity coupling system (e.g., the proximity coupling system 106).

The wireless communication interface 405 may be used to transmit signals to and/or receive signals from, an external proximity coupling system (e.g., the proximity coupling system 106). The signals transmitted by the wireless communication interface 405 may include a payment account identifier and/or other information stored in the control/storage circuitry 404. The signals received by the wireless communication interface 405 may include an interrogation signal, a power signal and/or other signals.

For example, wireless signals (e.g., RF signals) from an external proximity coupling system (e.g., the proximity coupling system 106) may be received by the antenna 406 and supplied to the transmit/receive circuitry 408, which in response may supply signals to the control/storage circuitry 404. The control/storage circuitry 404 may also supply signals to the transmit/receive circuitry 408, which in response may supply to the antenna 406 to be transmitted thereby to the external proximity coupling system.

In some embodiments, the control/storage circuitry 404 and/or the wireless communication interface 405 are configured to allow the proximity coupling system 124 to operate in accordance with the above-mentioned “PayPass” standard.

In some embodiments, the control/storage circuitry 404 comprises a simple memory device capable only of responding to a pre-defined set of commands. In some other embodiments, the control/storage circuitry 404 comprises a secure microcontroller capable of executing a pre-defined program.

In some embodiments, the switch network 402 and the control/storage circuitry are disposed in a single integrated circuit. In some embodiments, the control/storage circuitry 404 and the transmit/receive circuitry 408 are disposed in a single integrated circuit. In some embodiments, such integrated circuit comprises an RFID IC. In some embodiments, an RFID is a simple memory device capable only of responding to a pre-defined set of commands. In some other embodiments, an RFID comprises a microcontroller capable of executing a program. In some embodiments, an RFID IC comprises an IC that uses contactless technology, such as, for example, as specified in international standard ISO/IEC 14443.

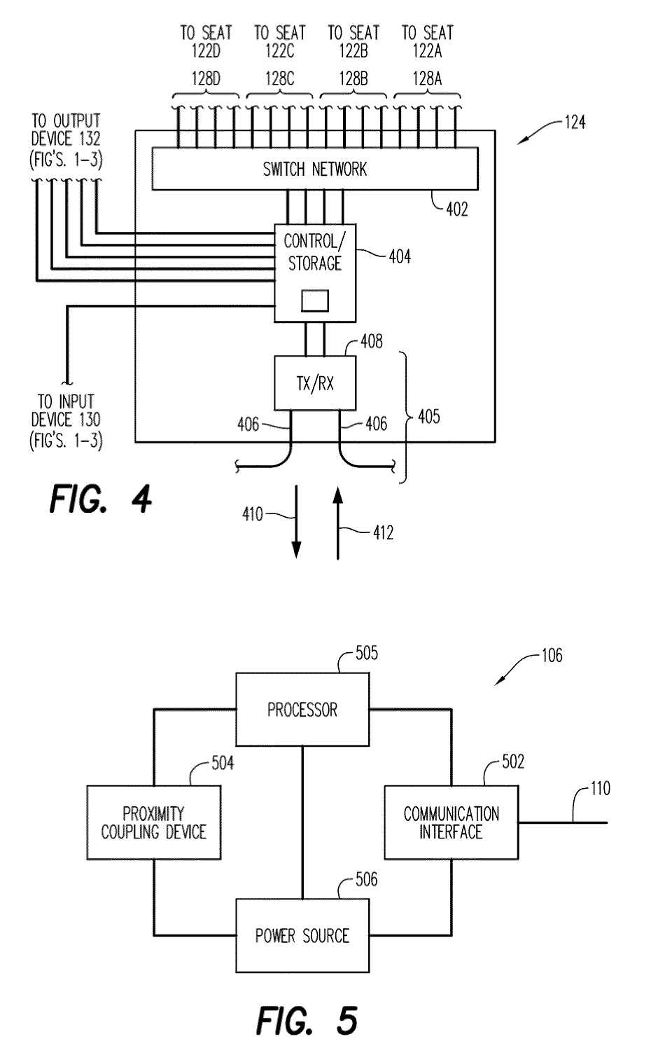

FIG. 5 is a schematic block diagram of the proximity coupling system 106, according to some embodiments. Referring to FIG. 5, in some embodiments, the proximity coupling system 106 includes a communication interface 502, a proximity coupling device 504, a processor 505 and power source 506.

The communication interface 502 may be used to facilitate communication with other devices and/or systems such as for example, the authorization device 110 (FIG. 1).

As further described hereinafter, the proximity coupling device 502 may be used to facilitate wireless communication with another proximity coupling system, such as for example the proximity coupling system 124 of the communication device 105.

The communication interface 502 and the proximity coupling device 504 may each be coupled to the processor 505, which may receive information from, and transmit information to, the communication interface 502 and the proximity coupling device 504.

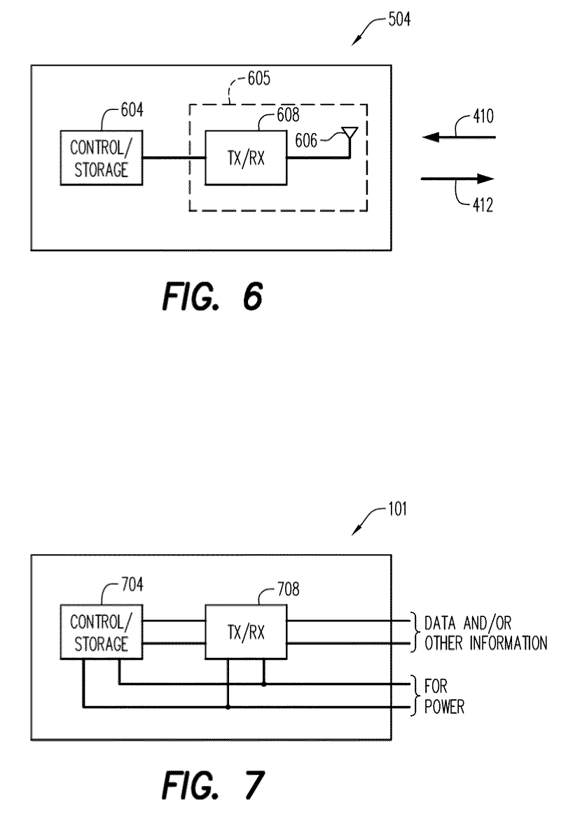

FIG. 6 is a schematic block diagram of the proximity coupling device 504, according to some embodiments. Referring to FIG. 6, in accordance with some embodiments, the proximity coupling device 504 includes control/storage circuitry 604 and a wireless communication interface 605.

The wireless communication interface 605 may comprise an antenna 606 and transmit/receive circuitry 608. The antenna 606 may be configured to transmit and receive radio frequency (RF) signals, e.g., signals 412, 410, respectively, and may comprise a loop antenna and/or any other suitable configuration. The transmit/receive circuitry 608 may couple the antenna 606 to the control/storage circuitry 604.

The wireless communication interface 605 may be used to transmit signals to, and/or receive signals from, an external proximity coupling system (e.g., the proximity coupling system 124 of the communication device 105) that may be within range of the proximity coupling device 504.

For example, wireless signals (e.g., RF signals) from an external proximity coupling system (e.g., the proximity coupling system 124 of the communication device 105) may be received by the antenna 606 and supplied to the transmit/receive circuitry 608, which in response may supply signals to the control/storage circuitry 604. The control/storage circuitry 604 may also supply signals to the transmit/receive circuitry 608, which in response may supply signals to the antenna 606 to be transmitted thereby to the external proximity coupling system.

In accordance with some embodiments, an external proximity coupling system is within range of the proximity coupling device 504 if the wireless communication interface of the external proximity coupling system is positioned in a field generated by the wireless communication interface 605.

In some embodiments, the control/storage circuitry 604 and the wireless communication interface 605 are configured to operate in accordance with the above-mentioned “PayPass” standard.

In some embodiments, the control/storage circuitry 604 comprises a simple memory device capable only of responding to a pre-defined set of commands. In some other embodiments, the control/storage circuitry 604 comprises a secure microcontroller capable of executing a pre-defined program.

In some embodiments, the control/storage circuitry 604 and the transmit/receive circuitry 408 are disposed in a single integrated circuit. In some embodiments, such integrated circuit uses contactless technology, such as, for example, as specified in international standard ISO/IEC 14443. In some embodiments, such integrated circuit may use NFC technology, and may comprise, for example, an NFC IC compliant with ISO/IEC 18092/ECMA-340 or ISO/IEC 21481/ECMA-352.

FIG. 7 is a schematic block diagram of an information device, according to some embodiments.

Referring to FIG. 7, in accordance with some embodiments, each of the information devices 101A-101D may comprise control/storage circuitry 704 and transmit receive circuitry 708.

The control/storage circuitry 704 may store a payment account identifier and/or other information to be transmitted to an external proximity coupling system (e.g., the proximity coupling system 106) via the control and proximity coupling system 124.

If the information device is selected, the circuitry may receive power from, and communicate with, the control and proximity coupling system 124.

The transmit/receive circuitry 708 may be used to transmit signals to and/or receive signals from, the control and proximity coupling system 124. The signals transmitted by the transmit/receive circuitry 708 may include a payment account identifier and/or other information stored in the control/storage circuitry 704. The signals received by the transmit/receive circuitry 708 may include an interrogation signal, a power signal and/or other signals.

In some embodiments, each information device 101A-101D is powered and/or enabled to operate only when such information device is selected.

In some embodiments, the control/storage circuitry 704 comprises a simple memory device capable only of responding to a pre-defined set of commands. In some other embodiments, the control/storage circuitry 704 comprises a secure microcontroller capable of executing a pre-defined program.

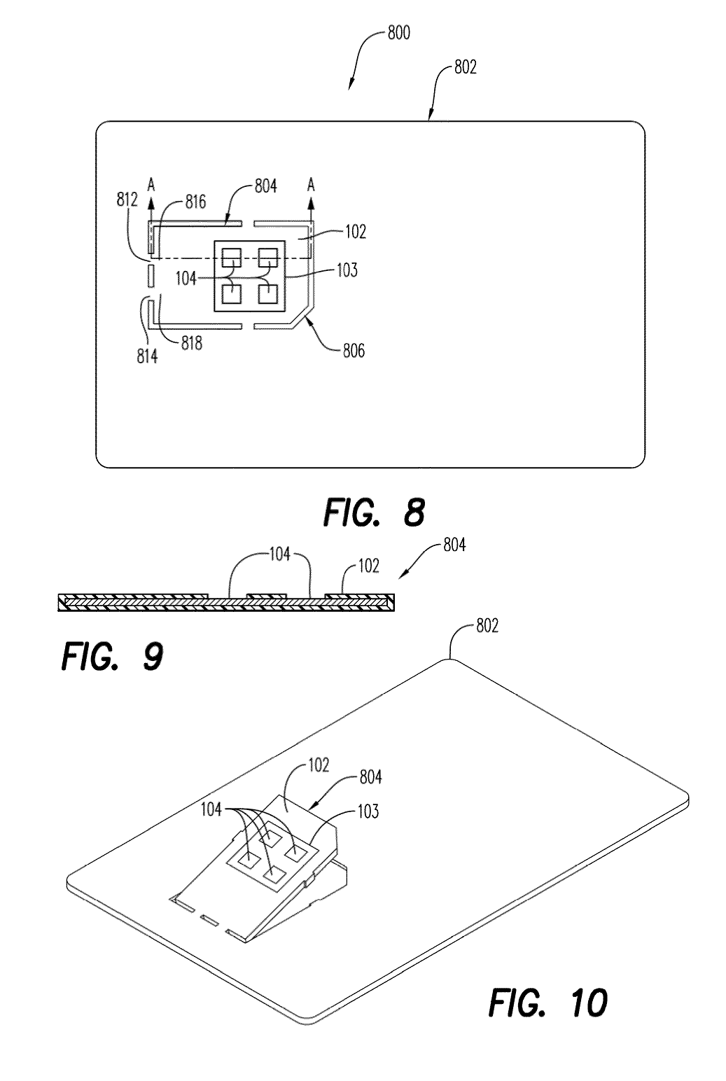

FIG. 8 is a plan view of a structure 800 that may be used in fabricating an information device, such as, for example, information device 101A, according to some embodiments. The structure 800 includes a card carrier 802 and a structure 804 that may initially define an information device blank. The carrier 802 may be generally card-shaped and may have dimensions as defined for the standard card referred to as “ID_1” in ISO/IEC standard 7810, promulgated by the International Standardization Organization. The structure 804 may have dimensions as defined for the standard card/module referred to as “ID0000” in standard 7810.

The structure 804 may include a body 102. The body 102 may be defined in part by punching or scoring 806 of the carrier 802 and may be joined to the carrier 202 by bridges 812, 814 and 815 located at locations without the scoring or punching 806.

The structure 804 may further include an integrated circuit 103 and a plurality of contact pads 104 formed thereon that may be used to electrically connect to the integrated circuit 103.

In accordance with some embodiments, “pre-personalization” and/or “personalization” may be carried out on the structure 804 to transform the structure 804 into an information device, such as, for example, information device 101A. As is known, pre-personalization and/or personalization may entail writing into the integrated circuit 103, certain information such as loading of keys to be used in subsequent transactions and setting of parameters (such as to select a particular card brand to be borne by the information device. If the information device is to be a payment card, information such as a payment card association brand, etc., may be printed on the body 102 and the information device may be effectively assigned to a particular payment account and/or a particular account holder by writing into the integrated circuit 103 information such as a payment card account number and the name of the account holder. Other information, such as expiration date, may also be stored in the integrated circuit 103. If the information device is to be a payment card, the payment card account number and/or other information (or a portion thereof) that was (or is to be) stored in the integrated circuit 103 may also be printed on the body 102.

In some embodiments, the structure 804 is thereafter usable as an information device.

In some embodiments, the body 102 may be detached from the carrier 202. In some embodiments, this may be done by the account holder, after the carrier 802 with the body 102 is mailed or otherwise issued to an account holder, e.g. account holder 104.

FIG. 9 is cross sectional view of the structure 804 along the direction A-A of FIG. 8, in accordance with some embodiments.

FIG. 10 is a perspective view of the structure 804 and the carrier 802 as the structure 102 is being detached therefrom.

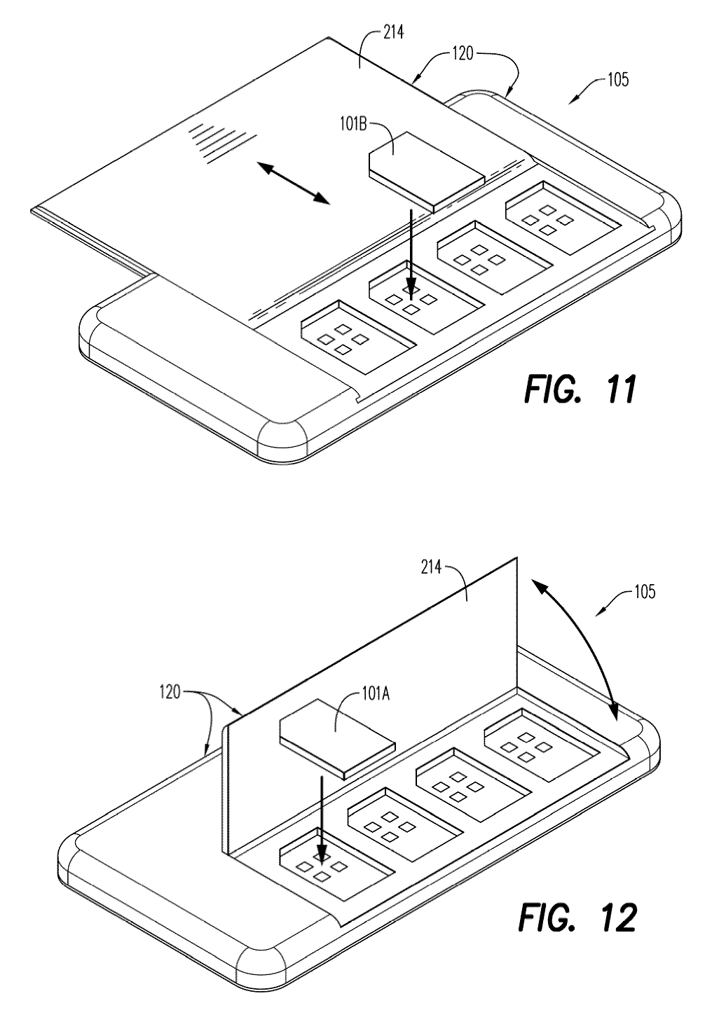

FIG. 11 is a perspective view of the communication device 105 and the information device 101B, according to some embodiments, with the communication device 105 in an open state.

Referring to FIG. 11, in some embodiments, the communication device 105 may be the same as and/or similar to the communication device 105 described hereinabove with respect to FIGS. 2A-2B and FIG. 3 except that the movable portion 214 is slidably attached to the rest of the body 120. A user may slide the portion 214 from a first (closed) position to a second (open) position relative to the rest of the body 120 so as to provide access to seats 122A-122D and thereby facilitate installation and/or removal of the information devices 101A-101D. In some embodiments, a releasable catch (not shown) is provided to releasably retain the portion 214 in the first (closed) position.

FIG. 12 is a perspective view of the communication device 105 and the information device 101B, according to some embodiments, with the communication device 105 in an open state.

Referring to FIG. 12, in some embodiments, the communication device 105 may be the same as and/or similar to the communication device 105 described hereinabove with respect to FIGS. 2A-2B and FIG. 3 except that the movable portion 214 is pivotably attached to the rest of the body 120. A user may pivot the portion 214 from a first (closed) position to a second (open) position relative to the rest of the body 120 so as to provide access to seats 122A-122D and thereby facilitate installation and/or removal of the information devices 101A-101D. In some embodiments, a releasable catch (not shown) is provided to releasably retain the portion 214 in the first (closed) position.

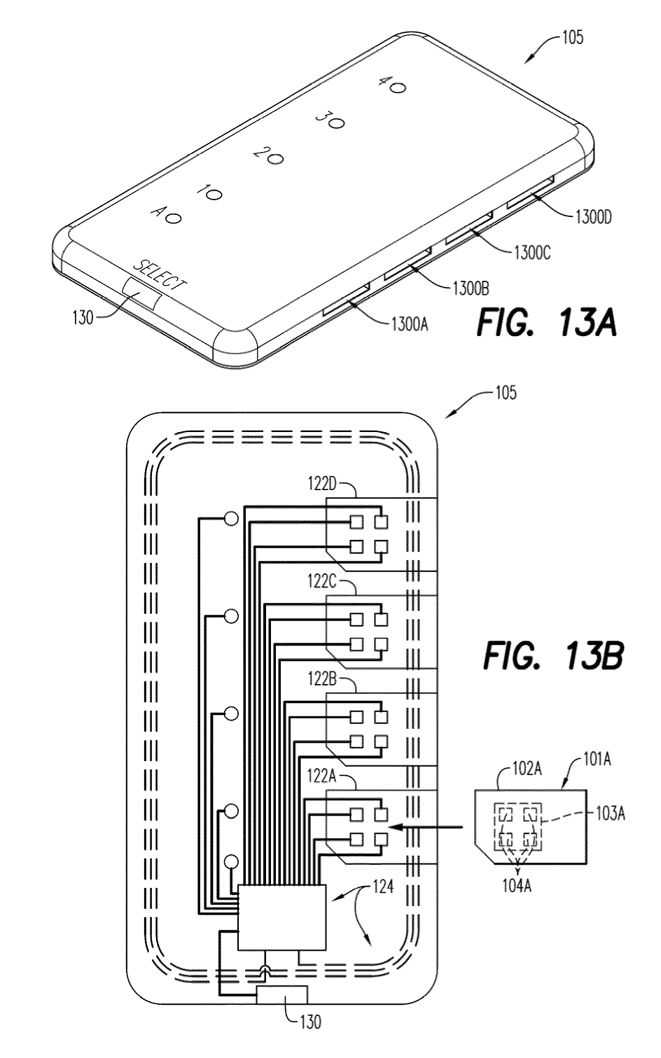

FIG. 13A is a perspective view of the communication device 105, according to some embodiments. In some payment related usage scenarios (e.g., where the communication device may be used in making payments and/or in any other association with payment transactions), this design option, whereby access to seats 122A-122D is provided via ports 1300A-1300D, respectively, may prove to be the best way to implement the communication device 105, but this may not necessarily hold true for all payment related usage scenarios and/or some other usage scenarios as requirements may vary from scenario to scenario.

FIG. 13B is a schematic plan view of a portion of the communication device of FIG. 13A and the information device 101A, according to some embodiments.

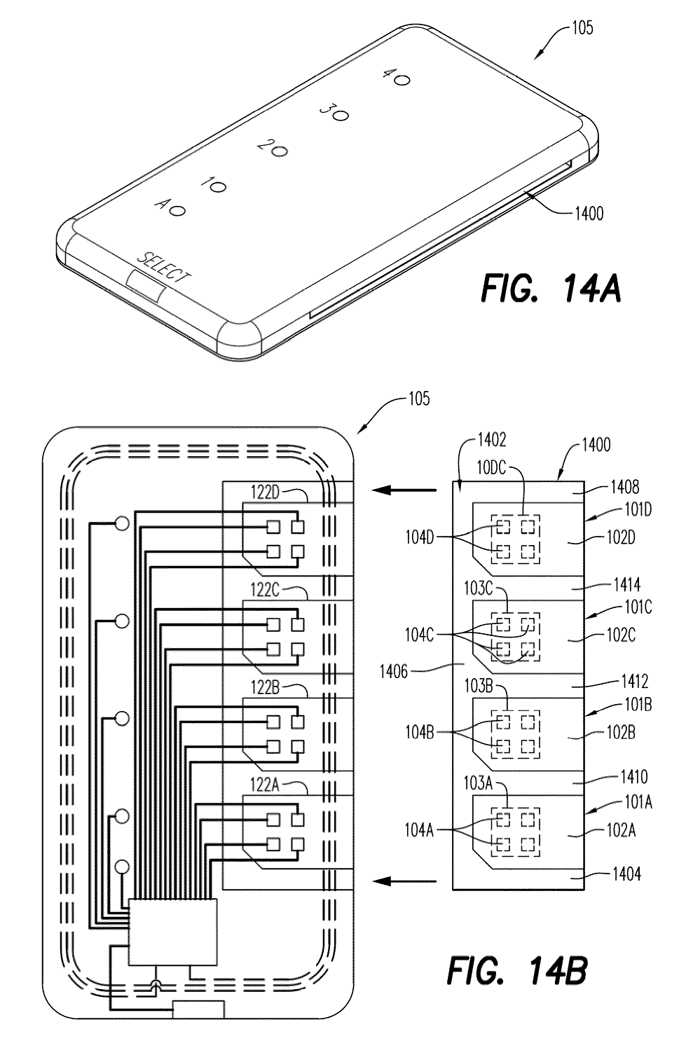

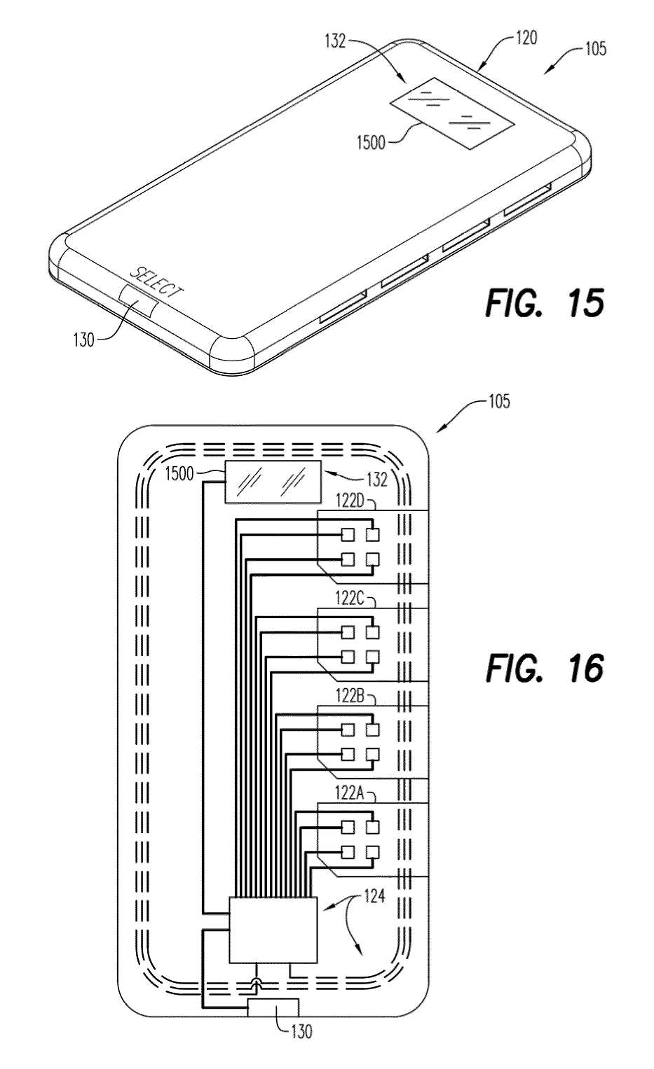

Referring to FIGS. 13A-14B, in some embodiments, the communication device 105 may be the same as and/or similar to the communication device 105 described hereinabove with respect to FIGS. 2A-2B and FIG. 3 except that access to seats 122A-122D is provided via ports 1300A-1300D, respectively. Thus, information devices 101A-101D may be inserted through ports 1300A-1300D to install information devices 101A-101D into seats 122A-122D, respectively. In some embodiments, ports 1300A-1300D have a shape (e.g., as shown) that helps guide the information devices 101A-101D into the seats 122A-122D, respectively.

FIG. 14A is a perspective view of the communication device 105, according to some embodiments.

FIG. 14B is a schematic plan view of a portion of the communication device of FIG. 14A and the information device 101A, according to some embodiments.

Referring to FIGS. 14A-14B, in some embodiments, the communication device 105 may be the same as and/or similar to the communication device 105 described hereinabove with respect to FIGS. 2A-2B and FIG. 3 except that access to some or all of the seats 122A-122D, e.g., all of the seats 122A-122D, is provided via a single port 1400.

As shown in FIG. 14B, some or all of the information devices 101A-101D, e.g., all of the information devices 101A-101D, may be integrated into a single module 1400.

Module 1400 may include a frame 1402 and some or all of the information devices 101A-101D, e.g., all of the information devices 101A-101D. In some embodiments, the frame 1402 includes portions 1404-1414 that define the frame 1402 and join the information devices 101A-101D. Some of the portions 1404-1414, e.g., portions 1410-1414, may extend between the information devices 101A-101D. For example, portion 1410 is shown extending between information device 101A and 101B, portion 1412 is shown extending between information device 101B and 101C, portion 1414 is shown extending between information device 101C and 101D.

Thus, module 1400 may be inserted through port 1400 to install information devices 101A-101D into seats 122A-122D, respectively. In some embodiments, the port 1400 has a shape (e.g., as shown) that helps guide the module 1400 such that information devices 101A-101D are positioned into the seats 122A-122D, respectively.

FIG. 15 is a perspective view of the communication device 105, according to some embodiments.

FIG. 16 is a schematic plan view of a portion of the communication device 105 of FIG. 16, according to some embodiments.

Referring to FIGS. 15-16, in some embodiments, the communication device 105 may be the same as and/or similar to the communication device 105 described hereinabove with respect to FIGS. 13-14 except that the output device 132 comprises a display device 1500 rather than the plurality of indicators 232, 232A-232D. The display device 1500 receives information from the control and proximity coupling system 124 and/or the information devices 101A-101D and displays information based at least in part thereon. In some embodiments, the information supplied to and/or by the display device includes information indicative of which information device 101A-101D is selected. Other information may also be supplied to and/or by the display device. In some embodiments, such other information may include information about the information devices 101A-101D installed in the communication device 105. Such information may include a brand and/or name of a supplier and/or a product with which one or more of the information devices are associated.

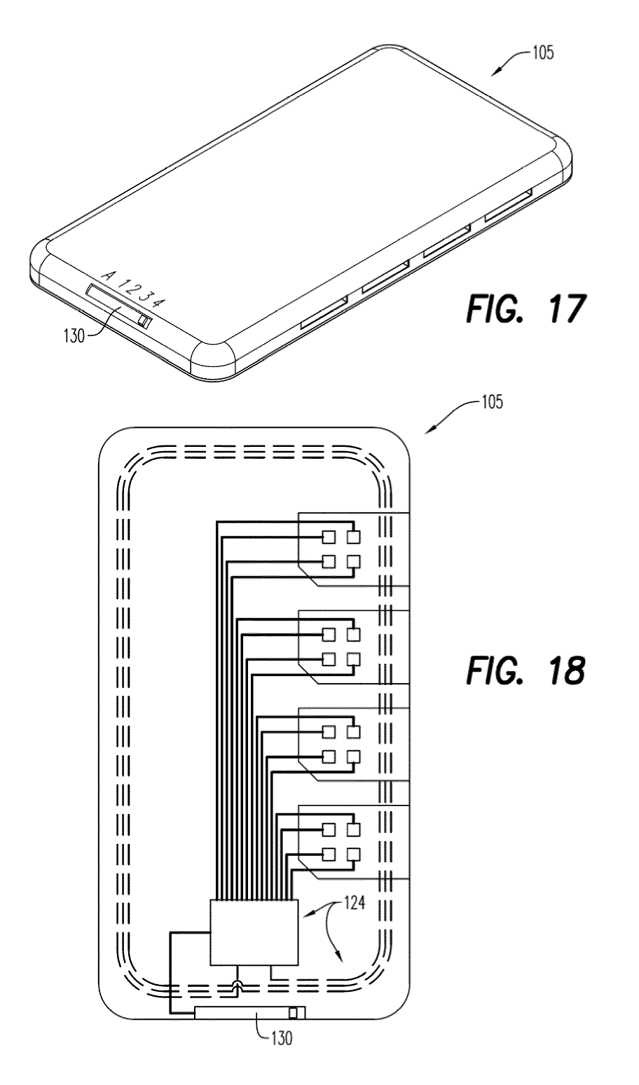

FIG. 17 is a perspective view of the communication device 105, according to some embodiments.

FIG. 18 is a schematic plan view of a portion of the communication device 105 of FIG. 17, according to some embodiments.

Referring to FIGS. 17-18, in some embodiments, the communication device 105 may be the same as and/or similar to the communication devices 105 described hereinabove with respect to FIGS. 13-16 except that the input device 130 comprises a switch having more than two positions. This design option for the input device 130 may prove to be the least complex and therefore most cost effective solution, but as technologies evolve this may not always be the case. In some embodiments, the number of positions is equal to the number of seats, e.g., seats 122A-122D, provided by the communication device 105. In such embodiments, each position, e.g., 1-4, may be associated with a respective one of the seats 122A-122D and may be a direct indication of the user's selection. For example, positioning the switch 130 at a first position, e.g., position 1, may indicate that the user selects the information device 101A installed in the first seat 122A. Positioning the switch 130 at a second position, e.g., 2, may indicate that the user selects the information device 101B installed in the second seat 122B. And so on. The control and proximity coupling system 124 may receive a signal indicating the position of the switch 130 and may select the information device associated therewith. For example, if the switch is at the first position, e.g., 1, the control and proximity coupling system 124 selects the information device 101A installed in the first seat 122A. If the switch is at the second position, e.g., 2, the control and proximity coupling system 124 selects the information device 101B installed in the second seat 122B.

In some embodiments, the number of positions is one more than the number of seats, e.g., seats 122A-122D, that are provided by the communication device 105, where the extra position, e.g., A, is used to indicate that user desires that the communication device 105 select the information device 105 based on a default and/or other mechanism. If the switch is in the extra position, e.g., A, the control and proximity coupling system 124 selects the information device based on the default and/or other mechanism.

The communication device 105 and/or the information devices 101A-101D may have shapes and/or contact arrangements different than those described above.

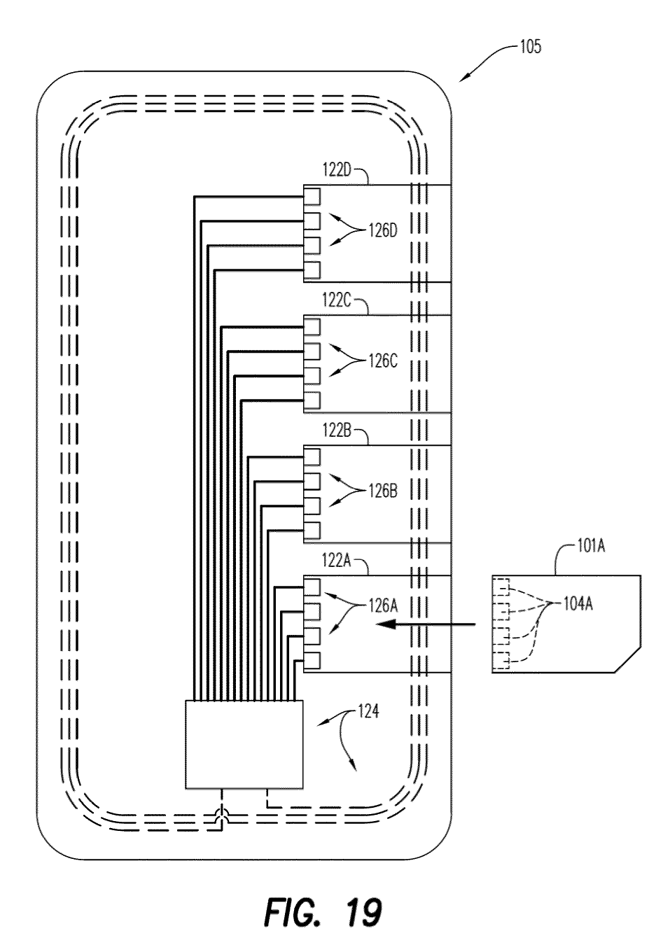

FIG. 19 is a schematic plan view of a portion of the communication device 105 and the information device 101A, according to some embodiments.

Referring to FIG. 19, in some embodiments, the communication device 105 may be the same as and/or similar to the communication devices 105 described hereinabove with respect to FIGS. 13-18 except that (i) the information devices 101A-101D may have a shape and/or contact arrangement that is different than those described above, such as for example, a shape and/or contact arrangement that is the same as and/or similar to that of a secure digital (SD) and (ii) the seats 122A-122D and electrical interface 126A-126D may have configuration corresponding to that of the information devices 101A-101D.

Although not shown, the input device 130 and/or the output device 132 may also be provided.

In some embodiments, the input device 130 and/or the output device 132 is comprised by the mobile device 134 rather than the communication device 105. In such embodiments, one or more signals may be communicated between the communication device 105 and the mobile device 134.

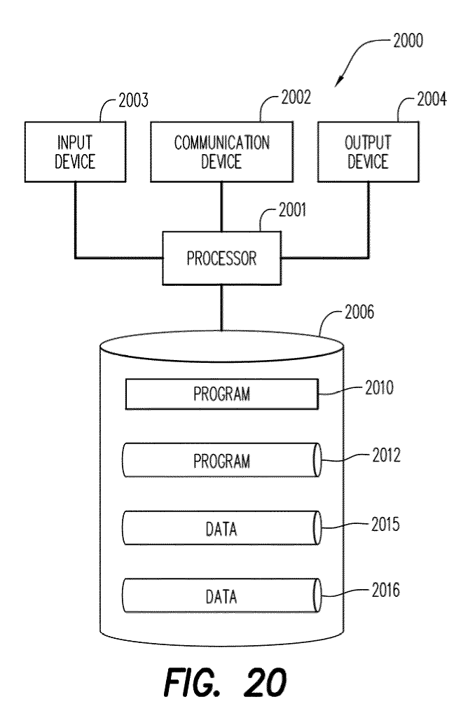

FIG. 20 is a block diagram of an architecture 2200 according to some embodiments. In some embodiments, one or more of the systems, devices, circuitry and/or portion(s) thereof disclosed herein may have an architecture that is the same as and/or similar to one or more portions of the architecture 2200.

Referring to FIG. 20, in accordance with some embodiments, the architecture 2000 includes a processor 2001 operatively coupled to a communication device 2002, an input device 2003, an output device 2004 and a storage device 2006.

In some embodiments, the processor 2001 may execute processor-executable program code to provide one or more portions of the one or more functions disclosed herein and/or to carry out one or more portions of one or more embodiments of one or more methods disclosed herein. In some embodiments, the processor 2001 may be a conventional microprocessor or microprocessors.

The communication device 2002 may be used to facilitate communication with other devices and/or systems. In some embodiments, communication device 2002 may be configured with hardware suitable to physically interface with one or more external devices and/or network connections. For example, communication device 2002 may comprise an Ethernet connection to a local area network through which architecture 2000 may receive and transmit information over the Internet and/or one or more other network(s).

The input device 2003 may comprise one or more devices used to input data and/or other information, such as, for example: a switch, a knob, a keyboard, a keypad, a track ball, touchpad, a mouse or other pointing device, a microphone, an infra-red (IR) port, etc.

The output device 2004 may comprise one or more devices used to output data and/or other information, such as, for example: an indicator, a display, a speaker, a printer, an IR port, a dock, etc.

The storage device 2006 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 2006 may store one or more programs 2010-2012, which may include one or more instructions to be executed by the processor 2001.

In some embodiments, the one or more programs may include one or more operating systems, database management systems, other applications, other information files, etc., for operation of the architecture 2000.

The storage device 2006 may store one or more databases 2015-2016 and/or criteria for one or more programs. As used herein a “database” may refer to one or more related or unrelated databases. Data and/or other information may be stored in any form. In some embodiments, data and/or other information may be stored in raw, excerpted, summarized and/or analyzed form.

As stated above, the communication device 105 may be mounted and/or otherwise attached to a mobile device 134. In some embodiments, adhesive is disposed between the communication device 105 and the mobile device 134 to mount and/or otherwise attach the communication device 105 to the mobile device 134.

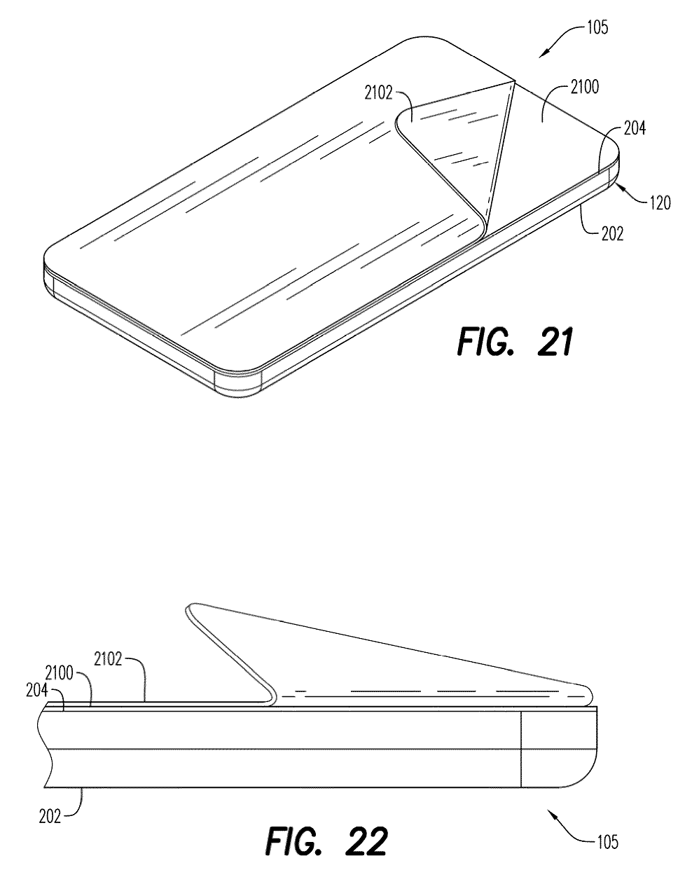

FIGS. 21-22 are perspective views of the communication device 105, according to some embodiments. Referring to FIGS. 21-22, in some embodiments, the communication device 105 may be the same as and/or similar to the communications devices 105 described hereinabove with respect to FIGS. 2A-2B, 3 and 11-19 except that (i) adhesive 2100 is disposed on the back 204 of the body 120 and (ii) the back 204 of the body 120 does not have rounded corners and edges and such that the entire back surface of the body 120 is generally flat. In some embodiments, the adhesive 2100 may be used to removably mount and/or otherwise removably attach the communication device 105 to the mobile device 134. In such embodiments, the communication device 105 may remain mounted and/or otherwise attached under ordinary handling conditions, but may be removable from the mobile device 134 without damaging the communication device 105 or the mobile device 134. In some other embodiments, the adhesive may permanently mount and/or otherwise attach the communication device 105 to the mobile device 134.

It may be desirable to select the adhesive material(s) based at least in part on the type of mobile device(s) to which the communication device may be mounted and/or otherwise attached. In some embodiments, the adhesive 2100 comprises a pressure sensitive adhesive.

The adhesive 2100 may be in the form of a layer, although this is not meant to imply that the adhesive must have a uniform thickness or be uniformly disposed across the back 204. For example, in some embodiments, adhesive may be disposed on only a portion of the back 204. In some embodiments, the adhesive disposed on the back 204 may have a grid or grid-like form. In some other embodiments, the adhesive may be in the form of an array of circles. In some other embodiments, the adhesive may be disposed only along one or more edges of the back 204 or one or more portions of such edges. In some other embodiments, the adhesive disposed on the back 204 may have an irregular configuration and/or any combination of the configurations.

One method for providing the adhesive is to coat the back 204 with an adhesive material in liquid form. Another method is to apply an adhesive material in a dry form. Dry adhesive suitable for use as a layer or backing may be obtained in large sheets and then cut to size. Another method is to employ double sided tape.

A releasable backing 2102 may be attached to the adhesive 2100. Such a backing 2102 may help keep the communication device 105 from sticking to objects prior to mounting and/or otherwise attaching the communication device 105 to a desired mobile device 134. In some embodiments, the releasable backing would need to be removed prior to mounting and/or otherwise attaching the communication device 105 to the mobile device 134.

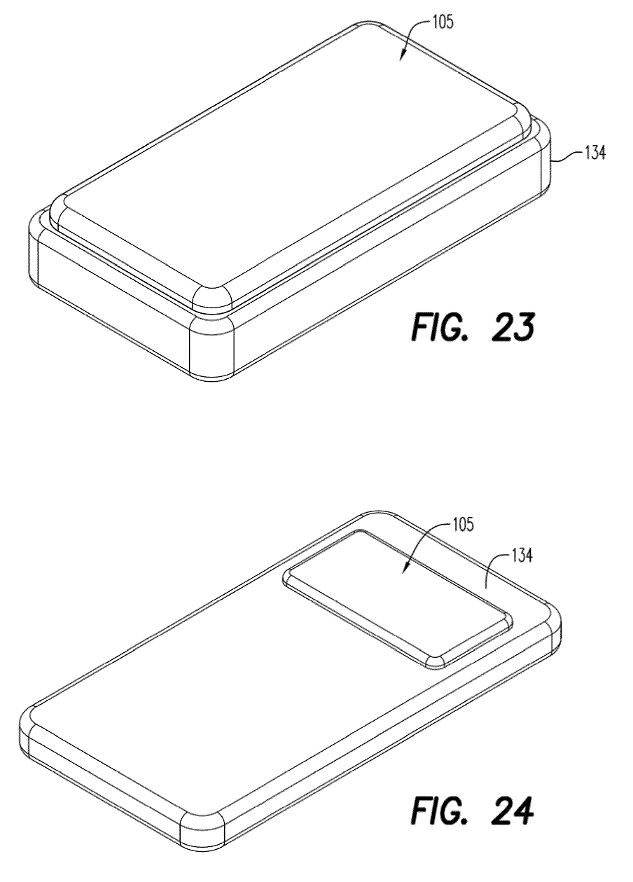

FIG. 23 is a perspective view of the communication device 105 mounted and/or otherwise attached to the mobile device 134, according to some embodiments.

Referring to FIG. 23, in some embodiments, the communication device 105 has a footprint that may be the same size and/or about the same size as a surface of the mobile device 134 to which the communication device is attached.

FIG. 24 is a perspective view of the communication device 105 mounted and/or otherwise attached to the mobile device 134, according to some embodiments.

Referring to FIG. 24, in some embodiments, the communication device 105 has a footprint that is smaller than the surface of the mobile device 134 to which the communication device is attached.

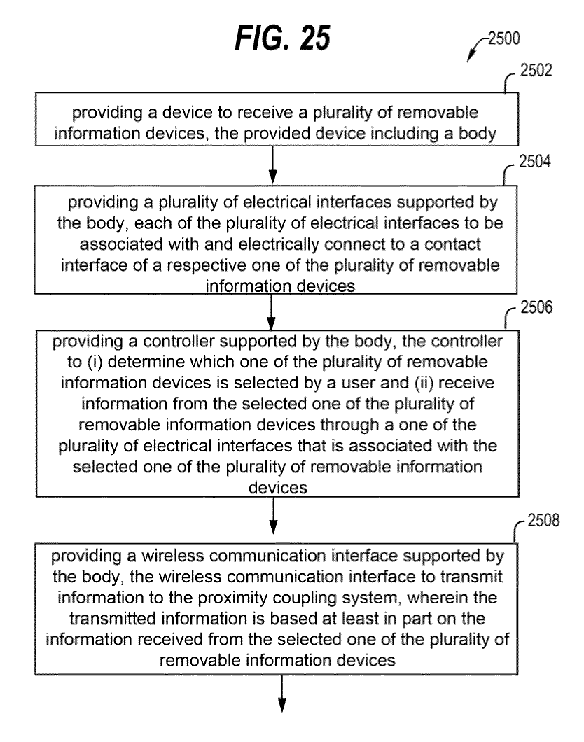

FIG. 25 is a flow chart 2500 of a method according to some embodiments. In some embodiments, one or more portions of the method may be performed by and/or in association with one or more portions of the system 100 and/or one or more entities associated therewith. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

At 2502, the method may include providing a device to receive a plurality of removable information devices, the provided device including a body.

At 2504, the method may further include providing a plurality of electrical interfaces supported by the body, each of the plurality of electrical interfaces to be associated with and electrically connect to a contact interface of a respective one of the plurality of removable information devices.

At 2506, the method may further include providing a controller supported by the body, the controller to (i) determine which one of the plurality of removable information devices is selected by a user and (ii) receive information from the selected one of the plurality of removable information devices through a one of the plurality of electrical interfaces that is associated with the selected one of the plurality of removable information devices.

At 2508, the method may further include providing a wireless communication interface supported by the body, the wireless communication interface to transmit information to the proximity coupling system, wherein the transmitted information is based at least in part on the information received from the selected one of the plurality of removable information devices.

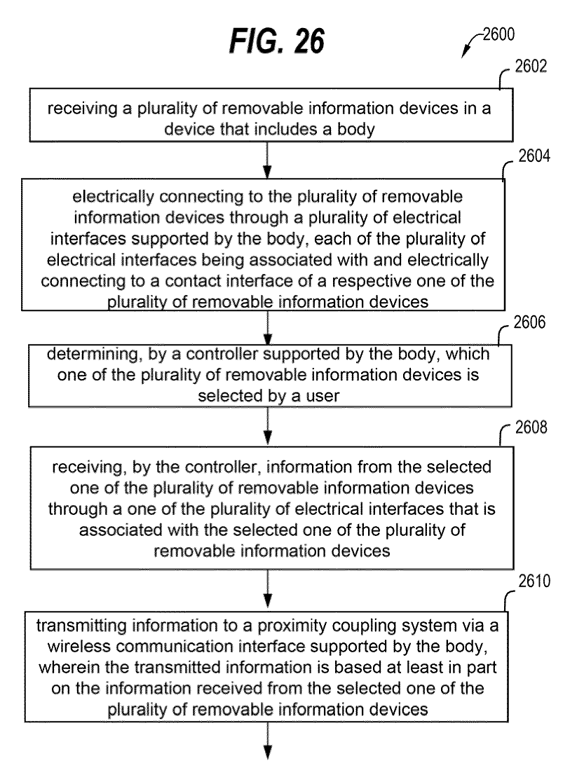

FIG. 26 is a flow chart 2600 of a method according to some embodiments. In some embodiments, one or more portions of the method may be performed by and/or in association with one or more portions of the system 100 and/or one or more entities associated therewith. The method is not limited to the order shown in the flow chart. Notably, some embodiments may employ one or more portions of the method without one or more other portions of the method.

At 2602, the method may include receiving a plurality of removable information devices in a device that includes a body.

At 2604, the method may further include electrically connecting to the plurality of removable information devices through a plurality of electrical interfaces supported by the body, each of the plurality of electrical interfaces being associated with and electrically connecting to a contact interface of a respective one of the plurality of removable information devices.

At 2606, the method may further include determining, by a controller supported by the body, which one of the plurality of removable information devices is selected by a user.

At 2608, the method may further include receiving, by the controller, information from the selected one of the plurality of removable information devices through a one of the plurality of electrical interfaces that is associated with the selected one of the plurality of removable information devices.

At 2610, the method may further include transmitting information to a proximity coupling system via a wireless communication interface supported by the body, wherein the transmitted information is based at least in part on the information received from the selected one of the plurality of removable information devices.

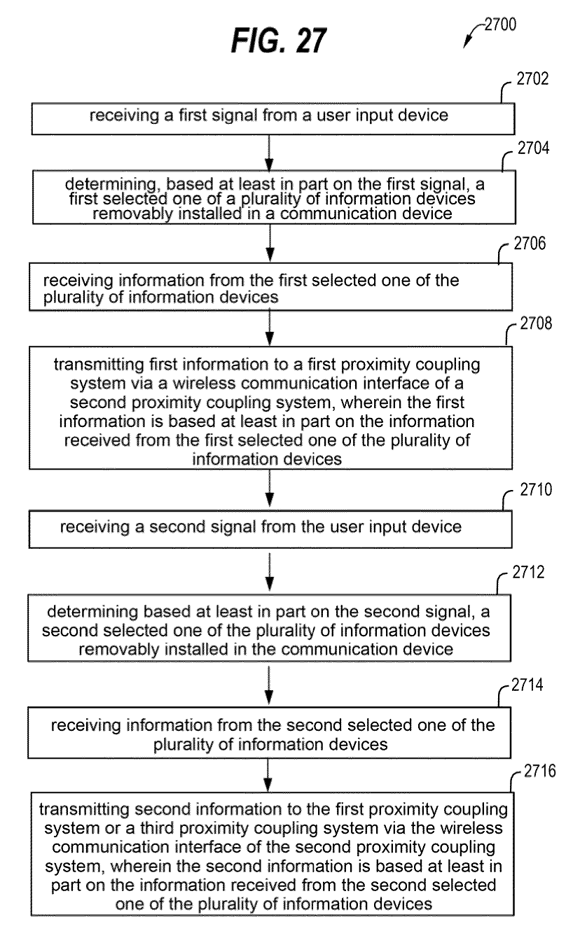

FIG. 27 is a flow chart 2700 of a method according to some embodiments. In some embodiments, one or more portions of the method may be performed by and/or in association with one or more portions of the system 100 and/or one or more entities associated therewith. The method is not limited to the order shown in the flow chart. Notably, some embodiments may employ one or more portions of the method without one or more other portions of the method.

At 2702, the method may include receiving a first signal from an input device.

At 2704, the method may further include determining, based at least in part on the first signal, a first selected one of a plurality of information devices removably installed in a communication device. In some embodiments, the first selected one of the plurality of information devices is associated with a first payment account. In some embodiments, the first selected one of the plurality of information devices comprises a payment card.

In some embodiments, the communication device is releasably mounted to a mobile device and an adhesive layer is disposed between the communication device and the mobile device.

At 2706, the method may further include receiving information from the first selected one of the plurality of information devices. In some embodiments, the information from the first selected one of the plurality of information devices comprises a first payment account identifier (which may be a payment account number).

At 2708, the method may further include transmitting first information to a first proximity coupling system via a wireless communication interface of a second proximity coupling system, wherein the first information is based at least in part on the information received from the first selected one of the plurality of information devices. In some embodiments, the communication device comprises the second proximity coupling system. In some embodiments, transmitting the first information via the wireless communication interface of the second proximity coupling system comprises transmitting the first information via near field communication. In some embodiments, transmitting the first information via the wireless communication interface of the second proximity coupling system comprises transmitting the first information while the communication device is in physical contact with the first proximity coupling system.

At 2710, the method may further include receiving a second signal from the input device.

At 2712, the method may further include determining based at least in part on the second signal, a second selected one of the plurality of information devices removably installed in the communication device. In some embodiments, the second selected one of the plurality of information devices is associated with a second payment account. In some embodiments, the second selected one of the plurality of information devices comprises a second payment card.

At 2714, the method may further include receiving information from the second selected one of the plurality of information devices. In some embodiments, the information from the second selected one of the plurality of information devices comprises a second account number.

At 2716, the method may further include transmitting second information to the first proximity coupling system or a third proximity coupling system via the wireless communication interface of the second proximity coupling system, wherein the second information is based at least in part on the information received from the second selected one of the plurality of information devices. In some embodiments, transmitting the second information via the wireless communication interface of the second proximity coupling system comprises transmitting the second information via near field communication.

The above description and/or the accompanying drawings are not meant to imply a fixed order or sequence of steps for any process referred to herein; rather any process disclosed herein may be performed in any order that is practicable, including but not limited to simultaneous performance of steps indicated as sequential.

In some embodiments, one or more portions of one or more embodiments disclosed herein may be embodied in a method, an apparatus, a computer program product, and/or an article where the article includes a machine readable storage medium with instructions that are stored thereon and executable by the machine. As used herein, a machine may be any type of machine. In some embodiments, a machine comprises a computer.

In some embodiments, one or parts of the communication device 105 are integral with one or more other parts of the communication device 105.

In some embodiments, the body 120 encloses the information devices 101A-101D and the other parts of the communication device 105. In some other embodiments, one or more portions of the information devices 101A-101D and/or one or more parts of the communication device 105 are not enclosed by the body 120 of the communication device 105.

In some embodiments, the communication device 105 includes one or more parts other than those described above. In some embodiments, the communication device 105 includes fewer than all of the parts described above for a given embodiment.

The communication device 105 and information devices 101A-101D may comprise any type of material(s) and may have any configurations and/or constructions.

For example, the communication device may have any number of seats and electrical interfaces to receive any number of information devices. The seats may be spaced apart from one another in one or more directions. In some embodiments, seats may be disposed in a linear array and spaced apart from one another in the x direction (and/or y direction). In some other embodiments, the seats may be disposed in a two dimensional array having a plurality of rows and/or columns. Thus, one or more of the seats may be spaced apart from one or more other seats in the x direction and/or y direction. In some embodiments, the seats may be disposed in a stack so as to be spaced apart from one another in the z direction. In some embodiments, the stack may define a linear array in the z direction.

In some embodiments, the configuration of the seats and/or electrical interfaces are based on the configuration of the information devices to be received and/or any other consideration(s) or combination thereof.

In some embodiments, one or more of the information devices 101A-101D may include information thereon and a portion of the communication device 105 may be transparent and/or open to allow the information to be read.

In some embodiments one or more portions of the communication device is designed to be camouflaged so as to make it less likely to be stolen.

In some embodiments, methods in addition to and/or in lieu of those described herein may be employed to enable and/or disable the communication device 105.

As used herein, a signal may be any type of signal.

An input device may include a tactile input device (e.g., a button, a keypad), an acoustic input device (e.g., a microphone) and/or any other type of input device. An output device may include a display device (e.g., a liquid crystal display) and/or an acoustic device (e.g., a speaker) and/or any other type of output device.

A circuit may be programmable or non programmable, general purpose or special purpose, dedicated or non dedicated, distributed or non distributed, shared or not shared, and/or any combination thereof. If the circuit has two or more distributed portions, the two or more portions may communicate with one another through a communication link. A circuit may include, for example, but is not limited to, hardware, software, firmware, hardwired circuits and/or any combination thereof.

Control/storage circuitry may comprise any type of control/storage circuitry. For example, control/storage circuitry may be programmable or non programmable, general purpose or special purpose, dedicated or non dedicated, distributed or non distributed, shared or not shared, and/or any combination thereof. Control/storage circuitry may include, but is not limited to, hardware, software, firmware, and/or any combination thereof. Hardware may include, but is not limited to off the shelf integrated circuits, custom integrated circuits and/or any combination thereof. In some embodiments, control/storage circuitry comprises a simple memory device capable only of responding to a pre-defined set of commands. In some embodiments, control/storage circuitry comprises a microcontroller and/or any other type of microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. Control/storage circuitry may employ continuous signals, periodically sampled signals, and/or any combination thereof. If control/storage circuitry is distributed, two or more portions of the control/storage circuitry may communicate with one another through a communication link.

Control/storage circuitry is sometimes referred to herein as a controller.

Thus, the term controller may comprise any type of controller. For example, a controller may be programmable or non programmable, general purpose or special purpose, dedicated or non dedicated, distributed or non distributed, shared or not shared, and/or any combination thereof. If the controller has two or more distributed portions, the two or more portions may communicate with one another through a communication link. A controller may include, for example, but is not limited to, hardware, software, firmware, hardwired circuits and/or any combination thereof. In some embodiments, a controller comprises a simple memory device capable only of responding to a pre-defined set of commands. In some embodiments, a controller comprises a microcontroller and/or any other type of microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A controller may employ continuous signals, periodically sampled signals, and/or any combination thereof. If a controller is distributed, two or more portions of the controller may communicate with one another through a communication link.

A processor may comprise any type of processor. For example, a processor may be programmable or non programmable, general purpose or special purpose, dedicated or non dedicated, distributed or non distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A processor may employ continuous signals, periodically sampled signals, and/or any combination thereof. If a processor is distributed, two or more portions of the processor may communicate with one another through a communication link.

A wireless communication interface may be any type of wireless communication interface.

A communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols.

A proximity payment device refers to any device, of any shape, which transmits to a point of sale terminal, by wireless transmission, a payment account identifier.

In some embodiments, the communication device includes one or more payment cards and operates as a type of proximity payment device.

An account number may be numeric, non numeric and/or a combination thereof.

A payment account may comprise any type of payment account. In some embodiments, a payment account comprises a pre-paid payment account. In some embodiments, a payment account comprises a checking account, a savings account, a debit account, and/or a credit account.

A payment account identifier may be numeric, non numeric and/or a combination thereof. In some embodiments, payment account data may include all data needed to initiate a payment transaction associated with a payment account.

In some embodiments, the information stored on an information device may include a name and/or other type of identifier associated (directly and/or indirectly) with a person, a social security number, an account identifier (which may be an account number) which may be associated with an account, an expiration date, a security code, medical information and/or any other type of information.

In some embodiments, an information device refers to a device, of any shape, that serves as one or more of a payment device, a loyalty and/or rewards related device, a transportation related device, an identification device, a passport and/or a source of any type of information associated with a holder of the information and/or the communication device in which the information device may be installed. The term “loyalty and/or rewards related device” refers to a card and/or other device that is issued by a merchant, organization and/or other entity and is associated with providing benefits to a holder of the information device who may purchase and/or use products and/or services provided by the merchant, organization and/or entity. The term “transportation related device” refers to a card or other device used to pay, or confirm or evidence payment of, a charge for using a transportation system and/or cards or the like issued by transportation systems (e.g., mass transit systems) for access to the transportation systems. The term passport refers to an internationally recognized travel.

The term “issued to” may include, but is not limited to, given to, loaned to, rented to, sold to, transferred to and/or provided to. The term “provided to” may include, but is not limited to, handed to and/or sent to. The term sent to may include, but is not limited to, mailed to.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although the present invention has been described in connection with specific exemplary embodiments, it should be understood that various changes, substitutions, and alterations can be made to the disclosed embodiments without departing from the spirit and scope of the invention as set forth in the appended claims.

What is claimed is:

1. Apparatus comprising:
a communication device to receive a plurality of removable information devices and transmit information to a proximity coupling system, the communication device including:
a body;
a plurality of electrical interfaces supported by the body, each of the plurality of electrical interfaces to electrically connect to a contact interface of an associated one of the plurality of removable information devices;
a controller supported by the body to (i) determine which one of the plurality of removable information devices is selected by a user and (ii) receive information from the selected one of the plurality of removable information devices through a one of the plurality of electrical interfaces that is associated with the selected one of the plurality of removable information devices; and
a wireless communication interface supported by the body to transmit information to the proximity coupling system, wherein the transmitted information is based at least in part information on the information received from the selected one of the plurality of removable information devices.

2. The apparatus of claim 1 wherein the selected one of the plurality of removable information devices is associated with a payment account.

3. The apparatus of claim 1 wherein the information from the selected one of the plurality of removable information devices comprises a payment account identifier.

4. The apparatus of claim 1 wherein the wireless communication interface comprises a wireless communication interface to transmit information to the proximity coupling system via near field communication and/or to receive information from the proximity coupling system via near field communication.

5. The apparatus of claim 1 wherein the wireless communication interface comprises a wireless communication interface to transmit information to the proximity coupling system while the communication device is in physical contact with the proximity coupling system and/or to receive information from the proximity coupling system while the communication device is in physical contact with the proximity coupling system.

6. The apparatus of claim 1 wherein the controller comprises a controller to (i) receive a first signal from a user input device, (ii) determine, based at least in part on the first signal from the user input device, that a first one of the plurality of removable information devices is selected by the user, (ii) receive information from the first one of the plurality of removable information devices through a one of the plurality of electrical interfaces that is associated with the first one of the plurality of removable information devices, (iii) receive a second signal from the user input device, (iv) determine, based at least in part on the second signal from the user input device, that a second one of the plurality of removable information devices is selected by the user and (v) receive information from the second one of the plurality of removable information devices through a one of the plurality of electrical interfaces that is associated with the first second of the plurality of removable information device; and
wherein the wireless communication interface comprises a wireless communication interface to (i) transmit first information to the proximity coupling system, wherein the first information is based at least in part on the information received from the first one of the plurality of removable information devices and (ii) transmit second information to a proximity coupling system, wherein the second information is based at least in part on the information received from the second one of the plurality of removable information devices.

7. A method comprising:
providing a device to receive a plurality of removable information devices, the provided device including a body;
providing a plurality of electrical interfaces supported by the body, each of the plurality of electrical interfaces to be associated with and electrically connect to a contact interface of a respective one of the plurality of removable information devices;
providing a controller supported by the body, the controller to (i) determine which one of the plurality of removable information devices is selected by a user and (ii) receive information from the selected one of the plurality of removable information devices through a one of the plurality of electrical interfaces that is associated with the selected one of the plurality of removable information devices; and
providing a wireless communication interface supported by the body, the wireless communication interface to transmit information to the proximity coupling system, wherein the transmitted information is based at least in part on the information received from the selected one of the plurality of removable information devices.

8. The method of claim 7 wherein the selected one of the plurality of removable information devices is associated with a payment account.

9. The method of claim 7 wherein the information from the selected one of the plurality of removable information devices comprises a payment account identifier.

10. The method of claim 7 wherein the wireless communication interface comprises a wireless communication interface to transmit information to the proximity coupling system via near field communication and to receive information from the proximity coupling system via near field communication.

11. The method of claim 7 wherein the wireless communication interface comprises a wireless communication interface to transmit information to the proximity coupling system while the communication device is in physical contact with the proximity coupling system and/or to receive information from the proximity coupling system while the communication device is in physical contact with the proximity coupling system.

12. The method of claim 1 wherein providing the controller comprises providing a controller to (i) receive a first signal from a user input device, (ii) determine, based at least in part on the first signal from the user input device, that a first one of the plurality of removable information devices is selected by the user, (ii) receive information from the first one of the plurality of removable information devices through a one of the plurality of electrical interfaces that is associated with the first one of the plurality of removable information devices, (iii) receive a second signal from the user input device, (iv) determine, based at least in part on the second signal from the user input device, that a second one of the plurality of removable information devices is selected by the user and (v) receive information from the second one of the plurality of removable information devices through a one of the plurality of electrical interfaces that is associated with the first second of the plurality of removable information device; and
wherein providing the wireless communication interface comprises providing a wireless communication interface to (i) transmit first information to the proximity coupling system, wherein the first information is based at least in part on the information received from the first one of the plurality of removable information devices and (ii) transmit second information to a proximity coupling system, wherein the second information is based at least in part on the information received from the second one of the plurality of removable information devices.

13. A method comprising:
receiving a plurality of removable information devices in a device that includes a body;
electrically connecting to the plurality of removable information devices through a plurality of electrical interfaces supported by the body, each of the plurality of electrical interfaces being associated with and electrically connecting to a contact interface of a respective one of the plurality of removable information devices;
determining, by a controller supported by the body, which one of the plurality of removable information devices is selected by a user;
receiving, by the controller, information from the selected one of the plurality of removable information devices through a one of the plurality of electrical interfaces that is associated with the selected one of the plurality of removable information devices; and
transmitting information to a proximity coupling system via a wireless communication interface supported by the body, wherein the transmitted information is based at least in part on the information received from the selected one of the plurality of removable information devices.

14. The method of claim 13 wherein the selected one of the plurality of removable information devices is associated with a payment account.

15. The method of claim 13 wherein the information from the selected one of the plurality of removable information devices comprises a payment account identifier.

16. The method of claim 13 wherein the wireless communication interface comprises a wireless communication interface to transmit information to the proximity coupling system via near field communication and to receive information from the proximity coupling system via near field communication.

17. The method of claim 13 wherein the wireless communication interface comprises a wireless communication interface to transmit information to the proximity coupling system while the communication device is in physical contact with the proximity coupling system and/or to receive information from the proximity coupling system while the communication device is in physical contact with the proximity coupling system.

18. The method of claim 13 wherein the determining, by the controller, which one of the plurality of removable information devices is selected by a user comprises determining, by the controller, a first selected one of the plurality of removable information devices based at least in part on a first signal from a user input device;
wherein the receiving, by the controller, information from the selected one of the plurality of removable information devices comprises receiving, by the controller, information from the first selected one of the plurality of removable information devices;
wherein the transmitted information is based at least in part on the information received from the first selected one of the plurality of removable information devices; and
wherein the method further comprises:
determining, by the controller, a second selected one of the plurality of removable information devices based at least in part on a second signal from the user input device;
receiving, by the controller, information from the second selected one of the plurality of removable information devices; and
transmitting second information to a proximity coupling system via the wireless communication interface supported by the body, wherein the transmitted second information is based at least in part on the information received from the second selected one of the plurality of removable information devices.
